(19) United States
(12) Patent Application Publication
(10) Pub. No.: US 2025/0173638 A1
(43) Pub. Date: May 29, 2025

(54) SCHEDULE PLANNING APPARATUS AND SCHEDULE PLANNING METHOD

(71) Applicant: Hitachi, Ltd., Tokyo (JP)

(72) Inventors: Akane SETO, Tokyo (JP); Junko HOSODA, Tokyo (JP); Kazuya UYAMA, Tokyo (JP); Hang DONG, Tokyo (JP)

(21) Appl. No.: 18/918,204

(22) Filed: Oct. 17, 2024

(30) Foreign Application Priority Data
Nov. 29, 2023 (JP) 2023-201705

(51) Int. Cl. G06Q 10/0631; G06Q 50/40

(52) U.S. Cl. CPC G06Q 10/06311; G06Q 50/40

(57) ABSTRACT

A schedule planning apparatus plans, based on a plurality of parameter values, a schedule combination including a transportation schedule and a charging schedule, evaluates, for each of the one or the plurality of planned schedule combinations, efficiency of transportation and easiness of schedule correction, and outputs information based on at least a part of a schedule combination in which the efficiency and the correction easiness are relatively high. For each of one or a plurality of kinds of constraint parameter value combinations, the constraint parameter value combination is a combination including a plurality of constraint parameter values respectively corresponding to the plurality of constraint parameter names. A constraint parameter value of at least one constraint parameter name affects the correction easiness.

### CROSS-REFERENCE TO RELATED APPLICATION

This application relates to and claims the benefit of priority from Japanese Patent Application number 2023-201705, filed on Nov. 29, 2023 the entire disclosure of which is incorporated herein by reference.

### BACKGROUND

The present invention generally relates to a technique for schedule planning and, more particularly, to a technique for planning a schedule of transportation by a motor-driven vehicle and a schedule of charging of the motor-driven vehicle.

When a motor-driven vehicle is adopted as a transportation vehicle such as a truck, it is desirable to plan a charging schedule besides a transportation schedule. For example, there is an electric automobile as the motor-driven vehicle. As a technique for planning a transportation schedule and a charging schedule of the electric automobile, there is a technique described in Japanese Patent Application Laid-Open Publication No. 2010-231258. In this publication, there is a description “A battery charging system characterized by integrating charging schedules of the electric automobiles and vehicle operation schedules of the electric automobiles and determining the schedules after adjusting the schedules”.

### SUMMARY

A plurality of prediction parameter values is referred to for planning of a transportation schedule and a charging schedule. The “prediction parameter values” are prediction values on which the transportation schedule and/or the charging schedule is based. Examples of the prediction parameter values include power consumption of a building and a cargo volume. A transportation schedule and a delivery schedule are planned on the weekend, at night on the previous day, or the like based on a plurality of parameter values including the plurality of prediction parameter values.

At least one prediction parameter value could have a prediction error. At least one prediction parameter values input for schedule planning is set to a value having a margin considering a risk of occurrence of the prediction error such that a person in charge of schedule does not need to correct a schedule once planned. A value serving as the margin is referred to as “buffer value”. The buffer value can also be referred to as tolerance of a prediction error of a prediction parameter value.

When it is assumed that prediction fails in a direction in which a transportation load increases, by setting large buffer values for prediction parameter values such as the number of necessary vehicles and an operation time, a schedule that does not need to be corrected even if prediction fails is expected. However, since the number of necessary vehicles, the operation time, and the like are estimated on the large side, the schedule is a schedule having low transportation efficiency.

Since a labor shortage has been a social problem in the transportation industry in recent years, it is desirable to improve efficiency. The buffer value only has to be reduced in order to improve the efficiency. However, if the buffer value is reduced, necessity of schedule correction increases.

One of representative inventions for solving at least one of the problems described above is as explained below. A schedule planning apparatus plans, based on a plurality of parameter values, a schedule combination including a transportation schedule for transporting a plurality of pieces of cargo to a plurality of points with a plurality of transportation vehicles including a plurality of motor-driven vehicles that require charging and a charging schedule that is a schedule for charging the plurality of motor-driven vehicles (a schedule based on the transportation schedule). The schedule planning apparatus evaluates, for each of one or a plurality of schedule combinations, efficiency of transportation and easiness of schedule correction and outputs information based on at least a part of a schedule combination in which efficiency and correction easiness are relatively high. The plurality of parameter values includes a plurality of prediction parameter values and one or a plurality of kinds of constraint parameter value combinations. The prediction parameter values are prediction values for parameter names. One or a plurality of constraint parameter values are present for each of a plurality of constraint parameter names. For each of the one or the plurality of kinds of constraint parameter value combinations, the constraint parameter value combination is a combination including a plurality of constraint parameter values respectively corresponding to the plurality of constraint parameter names. At least one constraint parameter value affects the correction easiness.

According to an aspect of the present invention, it is possible to provide a transportation schedule and a charging schedule for which schedule correction is easy even if necessity of the schedule correction occurs and in which transportation efficiency is high. Problems, components, and effects other than those explained above are clarified by the following explanation of an embodiment.

### BRIEF DESCRIPTION OF DRAWINGS

FIG. 1 is a diagram illustrating an example of a configuration of a schedule planning system and an example of a functional configuration of a schedule planning apparatus according to an embodiment;

FIG. 2 is a diagram illustrating an example of a hardware configuration of the schedule planning system according to the embodiment;

FIG. 3 is a flowchart illustrating an example of a series of processing performed in the embodiment;

FIG. 4 is a table illustrating an example of a data structure of prediction result information according to the embodiment;

FIG. 5 is a table illustrating an example of a data structure of parameter information according to the embodiment;

FIG. 6 is a table illustrating an example of a data structure of order information according to the embodiment;

FIG. 7 is a table illustrating an example of a data structure of vehicle information according to the embodiment;

FIG. 8 is a table illustrating an example of a data structure of point information according to the embodiment;

FIG. 9 is a table illustrating an example of a data structure of charger information according to the embodiment;

FIG. 10 is a table illustrating an example of a data structure of moving cost information according to the embodiment;

FIG. 11 is a table illustrating an example of a data structure of evaluation information according to the embodiment;

FIG. 12 is a table illustrating an example of a data structure of transportation schedule plan information according to the embodiment;

FIG. 13 is a table illustrating an example of a data structure of charging schedule plan information according to the embodiment;

FIG. 14 is a flowchart illustrating an example of schedule planning processing according to the embodiment;

FIG. 15 is a flowchart illustrating an example of schedule evaluation processing according to the embodiment;

FIG. 16 is a diagram illustrating an example of a transportation management screen according to the embodiment;

FIG. 17 is a diagram illustrating an example of a charging management screen according to the embodiment;

FIG. 18 is a diagram illustrating an example of a screen for vehicle according to the embodiment; and

FIG. 19 is a diagram illustrating an example of a screen for point according to the embodiment.

### DESCRIPTION OF EMBODIMENTS

In the following explanation, an “interface apparatus” may be one or more interface devices. The one or more interface devices may be at least one of the following.
One or more I/O (Input/Output) interface devices. The I/O (Input/Output) interface device is an interface device for at least one of an I/O device and a remote computer for display. The I/O interface device for the computer for display may be a communication interface device. At least one I/O device may be either an input apparatus such as a user interface device, for example, a keyboard and a pointing device and an output device such as a display device.
One or more communication interface devices. The one or more communication interface devices may be one or more communication interface devices of the same type (for example, one or more NICs (Network Interface Cards)) or may be two or more communication interface devices of different types (for example, an NIC and an HBA (Host Bus Adapter)).

In the following explanation, a “memory” is one or more memory devices that are an example of one or more storage devices and may be typically a main storage device. At least one memory device in the memory may be a volatile memory device or may be a nonvolatile memory device.

In the following explanation, a “permanent storage apparatus” may be one or more permanent storage devices that are an example of one or more storage devices. The permanent storage device may be typically a nonvolatile storage device (for example, an auxiliary storage device) and may be, specifically, for example, an HDD (Hard Disk Drive), an SSD (Solid State Drive), an NVME (Non-Volatile Memory Express) drive, or an SCM (Storage Class Memory).

In the following explanation, a “storage apparatus” may be at least the memory of the memory and the permanent storage apparatus.

In the following explanation, a “processor” may be one or more processor devices. At least one processor device may be typically a microprocessor device such as a CPU (Central Processing Unit) but may be a processor device of another type such as a GPU (Graphics Processing Unit). The at least one processor device may be a single core or may be multi core. The at least one processor device may be a processor core. The at least one processor device may be a processor device in a broad sense such as a circuit that is an aggregate of gate arrays by a hardware description language that performs a part or entire processing (for example, an FPGA (Field-Programmable Gate Array), a CPLD (Complex Programmable Logic Device), or an ASIC (Application Specific Integrated Circuit)).

In the following explanation, a function is sometimes explained by an expression of “yyy unit”. However, the function may be implemented by one or more computer programs being executed by a processor, may be implemented by one or more hardware circuits (for example, an FPGA or an ASIC), or may be implemented by a combination of the one or more computer programs and the one or more hardware circuits. When the function is implemented by the programs being executed by the processor, since determined processing is performed using, for example, a storage apparatus and/or an interface apparatus as appropriate, the function may be at least a part of the processor. Processing explained using the function as a subject may be processing performed by the processor or an apparatus including the processor. The programs may be installed from a program source. The program source may be, for example, a storage medium (for example, a non-transitory storage medium) readable by a program distribution computer or a computer. The explanation of functions is an example. A plurality of functions may be combined into one function or one function may be divided into a plurality of functions.

As information (identification information or an identifier) for identifying an element, any information (for example, at least one of an “ID”, a “name”, and a “number”) may be adopted.

In the following explanation, a unit of “date and time” may be a unit rougher than or a unit finer than month, date, hour, and minute.

An embodiment is explained below with reference to the drawings. In the present embodiment, in principle, the same components are denoted by the same reference numerals and signs, and redundant explanation of the components is omitted. Note that the present embodiment is only an example for implementing the present invention and does not limit the technical scope of the present invention.

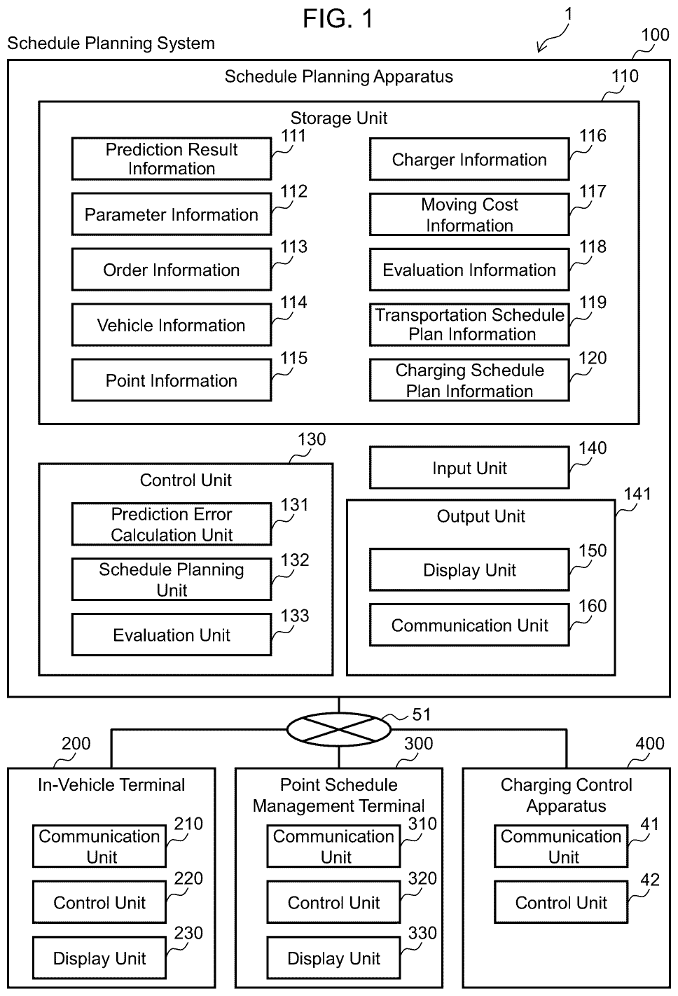

FIG. 1 is a diagram illustrating an example of a configuration of a schedule planning system 1 and a functional configuration of a schedule planning apparatus 100 according to the embodiment.

The schedule planning system 1 includes the schedule planning apparatus 100 and an in-vehicle terminal 200, a point schedule management terminal 300, and a charging control apparatus 400 communicably connected to the schedule planning apparatus 100 via a network 51. Each of the schedule planning apparatus 100, the in-vehicle terminal 200, the schedule management terminal 300, and the charging control apparatus 400 may include an interface apparatus, a storage apparatus, and a processor connected to the interface apparatus and the storage apparatus.

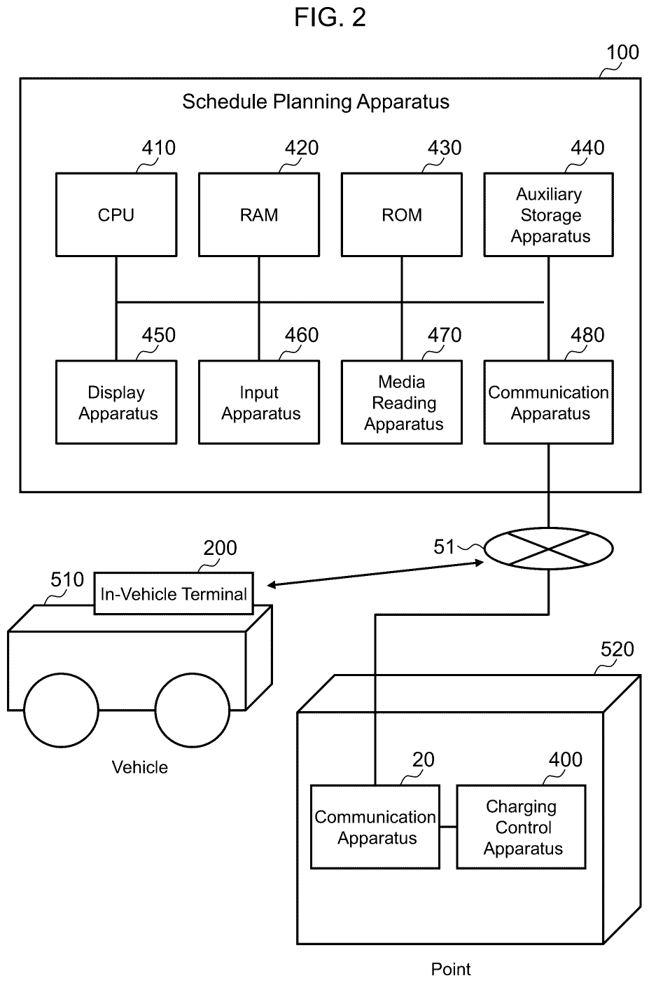

The schedule planning apparatus 100 includes functions such as a storage unit 110, a control unit 130, an input unit 140, and an output unit 141 (for example, a function including at least one of a display unit 150 and a communication unit 160). These functions may be implemented by a CPU 410 (see FIG. 2) of the schedule planning apparatus 100 executing a program.

The storage unit 110 stores prediction result information 111, parameter information 112, order information 113, vehicle information 114, point information 115, charger information 116, moving cost information 117, evaluation information 118, transportation schedule plan information 119, and charging schedule plan information 120. The prediction result information 111 is information concerning predictions and results in transportation schedules and charging schedules in the past. The parameter information 112 is information concerning calculation parameters considered when a transportation schedule or a charging schedule is planned. The order information 113 is order information of a piece of cargo to be transported. The vehicle information 114 is information concerning a vehicle usable at the time of schedule execution. The point information 115 is information concerning a point where at least one of cargo pickup, delivery, and charging is carried out. The charger information 116 is information concerning a charger installed at a point that is a target of a charging schedule. The moving cost information 117 is information defining cost required for movement between two points. The evaluation information 118 is information concerning parameters for evaluating a combination of a planned transportation schedule plan and a planned charging schedule plan. The transportation schedule plan information 119 is information concerning a transportation schedule plan created by the control unit 130. The charging schedule plan information 120 is information concerning a charging schedule plan created by the control unit 130.

The control unit 130 includes a prediction error calculation unit 131, a schedule planning unit 132, and an evaluation unit 133. The prediction error calculation unit 131 calculates a buffer value of input information using the prediction result information 111 and stores the calculated buffer value in the parameter information 112. The schedule planning unit 132 generates a transportation schedule plan and a charging schedule plan using the parameter information 112, the order information 113, the vehicle information 114, the point information 115, the charger information 116, and the moving cost information 117 and stores the transportation schedule plan in the transportation schedule plan information 119 and stores the charging schedule plan in the charging schedule plan information 120. The evaluation unit 133 evaluates correction cost of schedule correction from the viewpoint of efficiency of transportation, necessity of schedule correction, and easiness of schedule correction using the parameter information 112, the transportation schedule plan information 119, and the charging schedule plan information 120 and stores a best combination of a transportation schedule plan and a charging schedule plan as an optimum schedule.

The input unit 140 receives input operation from a user.

The output unit 141 outputs information. For example, the display unit 150 displays, on a display apparatus 450 (see FIG. 2), a transportation schedule and a charging schedule planned by the control unit 130. The communication unit 160 transmits and receives information between the in-vehicle terminal 200 and the point schedule management terminal 300 and the charging control apparatus 400.

The in-vehicle terminal 200 is an information processing terminal mounted on a motor-driven vehicle (for example, an electric automobile) serving as a transportation vehicle. The in-vehicle terminal 200 includes functions such as a communication unit 210, a control unit 220, and a display unit 230. The communication unit 210 transmits current situation information of the own vehicle (information representing a current situation of the own vehicle) to the communication unit 160 and receives information for vehicle of the own vehicle (for example, information representing a transportation schedule of the own vehicle) transmitted from the communication unit 160 of the schedule planning apparatus 100. The “own vehicle” is the transportation vehicle including the in-vehicle terminal 200. When the own vehicle is automatically driven, the control unit 220 controls the own vehicle to perform transportation as indicated by the transportation schedule represented by the received information for vehicle. When a driver drives the own vehicle, the control unit 220 instructs the display unit 230 to display an alert when the transportation schedule represented by the information for vehicle and a result deviate by a fixed amount or more. The display unit 230 displays the transportation schedule represented by the received information for vehicle and the alert instructed from the control unit 220 on a display screen included in the in-vehicle terminal 200.

The schedule management terminal 300 is disposed at each point. The schedule management terminal 300 includes functions such as a communication unit 310, a control unit 320, and a display unit 330. The communication unit 310 receives information for point of an own point (for example, information representing a transportation schedule and/or a charging schedule concerning the own point) transmitted from the communication unit 160 of the schedule planning apparatus 100. The “own point” is a point where the schedule management terminal 300 is disposed. The control unit 320 determines whether an acceptance system for cargo pickup, delivery, or charging is arranged and, if the acceptance system is not arranged, issues a work instruction. The display unit 330 displays, on a display screen included in the schedule management terminal 300, the transportation schedule and the charging schedule represented by the received information for point.

The charging control apparatus 400 is disposed in each of a plurality of (or one) charging points among a plurality of points. The “charging point” is a point where charging can be performed. The charging control apparatus 400 includes functions such as a communication unit 41 and a control unit 42. The communication unit 41 receives information for point of an own charging point (for example, information representing a charging schedule at the own charging point) transmitted from the communication unit 160 of the schedule planning apparatus 100. The “own charging point” is a charging point where the charging control apparatus 400 is disposed. The control unit 42 controls a charger and charging for a vehicle according to the charging schedule represented by the information for point of the own charging point.

FIG. 2 is a block diagram illustrating an example of a hardware configuration of the schedule planning system 1 according to the embodiment.

The schedule planning apparatus 100 includes a CPU (Central Processing Unit) 410, a RAM (Random Access Memory) 420, a ROM (Read Only Memory) 430, an auxiliary storage apparatus 440, a display apparatus 450, an input apparatus 460, a media reading apparatus 470, and a communication apparatus 480. The schedule planning apparatus 100 is capable of performing, via the communication apparatus 480, transmission and reception to and from the in-vehicle terminal 200 (not illustrated in FIG. 2) of a vehicle 510, the schedule management terminal 300 (not illustrated in FIG. 2) at a point 520 that performs cargo pickup, delivery, and charging, and the charging control apparatus 400 (not illustrated in FIG. 2) at the point 520 that performs charging. The media reading apparatus 470 and the communication apparatus 480 are examples of an interface apparatus. The RAM 420 and the ROM 430 are examples of a memory. The auxiliary storage apparatus 440 is an example of a permanent storage apparatus. The CPU 410 is an example of a processor.

The CPU 410 is an apparatus that executes various arithmetic operations. The RAM 420 is a memory that stores programs to be executed by the CPU 410, data, and the like. The ROM 430 is a memory that stores, for example, a program necessary for starting a schedule planning system. The auxiliary storage apparatus 440 is an apparatus such as an HDD (Hard Disk Drive). The display apparatus 450 is an apparatus such as a liquid crystal display. The input apparatus 460 is an apparatus used for information input to the schedule planning apparatus 100 by the user such as a keyboard. The media reading apparatus 470 is an apparatus that reads information of a portable storage medium such as a USB (Universal Serial Bus) memory (USB is a registered trademark). The communication apparatus 480 is an apparatus that transmits and receives information to and from an external apparatus via the network 51. For example, the information 111 to 120 illustrated in FIG. 1 is stored in the RAM 420 and the like.

The in-vehicle terminal 200 is present in the vehicle 510. The in-vehicle terminal 200 communicates with the schedule planning apparatus 100 via the network 51. A communication apparatus 20 that performs communication via the network 51 and the charging control apparatus 400 are provided at the point 520 where charging is possible. The communication unit 41 of the charging control apparatus 400 can communicate with the schedule planning apparatus 100 through the communication apparatus 20.

In the present embodiment, the schedule planning apparatus 100 is a physical computer system (one or a plurality of computers). However, the schedule planning apparatus 100 may be a logical computer system based on a physical computer system (for example, a system serving as a cloud computer service based on the foundations of cloud computing). For example, the display apparatus 450 and the input apparatus 460 may be absent. The schedule planning apparatus 100 may communicate with, via the communication apparatus 480, a remote client computer including a display apparatus and an input apparatus.

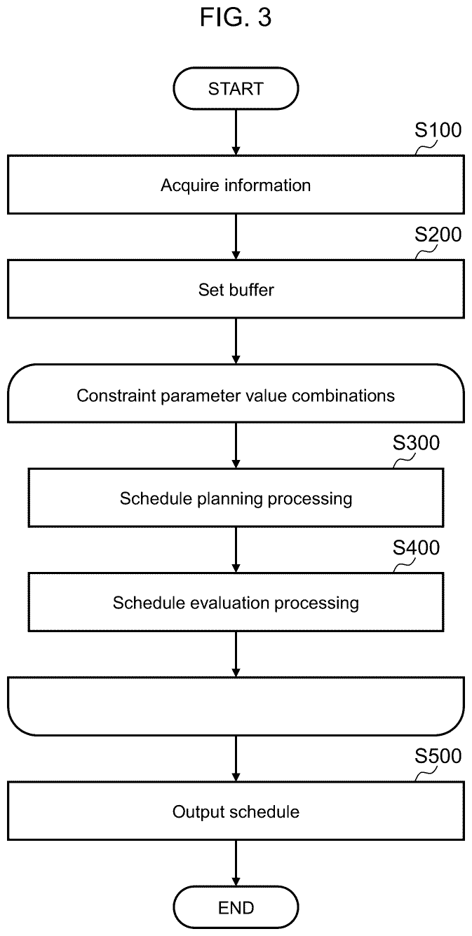

FIG. 3 is a flowchart illustrating an example of a series of processing according to the embodiment.

The input unit 140 acquires the information 111 to 118 in response to input operation from at least one of the in-vehicle terminal 200, the schedule management terminal 300, and the input apparatus 460 (S100). At least a part of the acquired information 111 to 118 may include information input by the input operation.

Subsequently, the prediction error calculation unit 131 calculates a buffer taken into consideration at the time of scheduling and stores the calculated buffer in the parameter information 112 (S200).

Subsequently, the schedule planning unit 132 generates a transportation schedule plan and a charging schedule plan, stores the generated transportation schedule plan in the transportation schedule plan information 119, and stores the generated charging schedule plan in the charging schedule plan information 120 (S300).

Subsequently, the evaluation unit 133 performs schedule evaluation processing (S400). The schedule evaluation processing is processing for evaluating a combination of the transportation schedule plan and the charging schedule plan and, when a good evaluation is obtained, storing the schedule plans.

Lastly, a schedule is output (S500). Specifically, the display unit 150 displays the schedule on the display apparatus 450. Via the network 51, the communication unit 160 transmits information for vehicle to the in-vehicle terminal 200, transmits information for point to the schedule management terminal 300, and transmits information for point of a charging point to the charging control apparatus 400.

S300 and S400 are performed for each of a plurality of kinds (in the present embodiment, all kinds) of constraint parameter value combinations. The “constraint parameter value combination” is a combination including a plurality of constraint parameters. For example, when “a1” and “a2” are present as constraint parameter values of a constraint parameter name “A” and “b1” and “b2” are present as constraint parameter values of a constraint parameter name “B”, all the kinds of constraint parameter value combinations are four kinds of combinations of (a1, b1), (a2, b1), (a1, b2), and (a2, b2). The “constraint parameter value” is a parameter value that affects easiness of schedule correction. The “easiness of schedule correction” is one of evaluation items of a schedule. Details of the “constraint parameter value” and the “easiness of schedule correction” are explained below.

Steps in FIG. 3 are explained below.

In S100, the prediction result information 111, the parameter information 112, the order information 113, the vehicle information 114, the point information 115, the charger information 116, the moving cost information 117, and the evaluation information 118 are acquired. Examples of the information 111 to 118 are explained below. Structures (information included in entries) of the information 111 to 118 are not limited to the examples explained below.

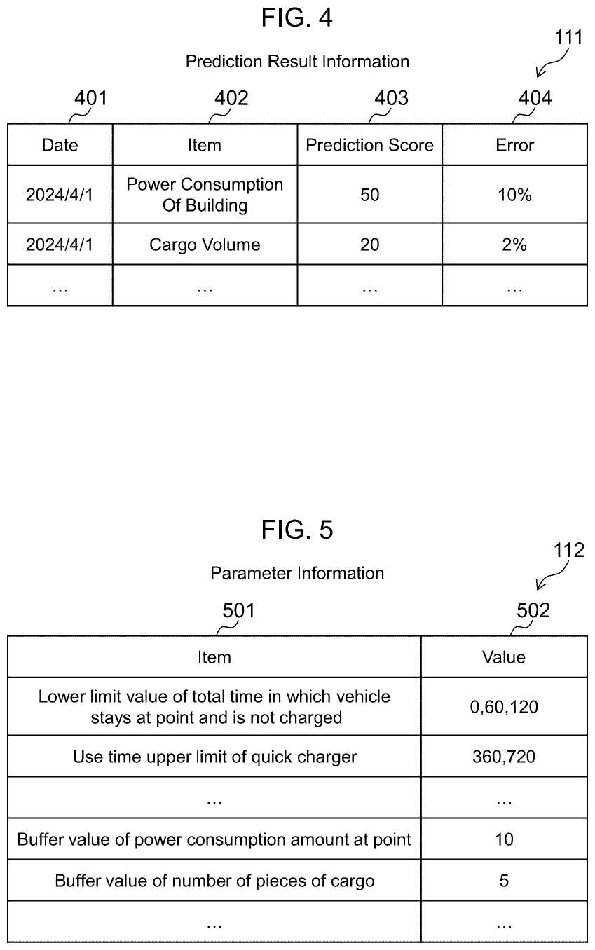

FIG. 4 is a table illustrating an example of a data structure of the prediction result information 111 according to the embodiment.

The prediction result information 111 includes entries for each set of a prediction and a result. The entries include information such as a date 401, an item 402, a prediction score 403, and an error 404.

The date 401 represents a schedule target date (a date targeted by a schedule). The item 402 represents an item serving as a prediction parameter name. The prediction score 403 is a prediction parameter value. The error 404 represents a prediction error, that is, an error between the prediction parameter value and a result value (an actual value) obtained for the prediction parameter name on the schedule target date. As the item 402 (the prediction parameter name), for example, at least one of power consumption of a building, a demand target, residual electric energy at a start time, electricity consumption, power consumption cost between points, delivery hour, and a cargo volume may be adopted.

FIG. 5 is a table illustrating an example of a data structure of the parameter information 112 according to the embodiment.

The parameter information 112 includes entries for each set of an item and a value. The entries include information such as an item 501 and a value 502.

The item 501 represents a constraint parameter name or a buffer name. The value 502 represents a constraint parameter value or a buffer value. Depending on a constraint parameter name (or a buffer name), a plurality of constraint parameter values (or a plurality of buffer values) can be set as the value 502. Specifically, for example, for a constraint parameter name “a lower limit value of a total time in which a vehicle stays at a point and is not charged”, there are three constraint parameter values “0”, “60”, and “120”.

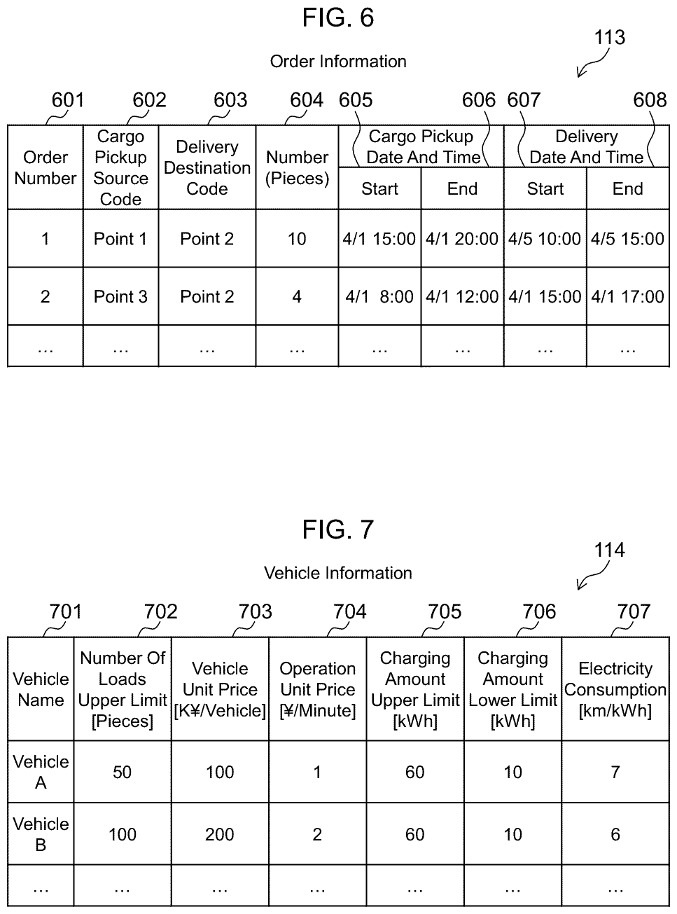

FIG. 6 is a table illustrating an example of a data structure of the order information 113 according to the embodiment.

The order information 113 includes entries for each order. The entries include information such as an order number 601, a cargo pickup source code 602, a delivery destination code 603, a number 604, a cargo pickup date and time (start) 605, a cargo pickup date and time (end) 606, a delivery date and time (start) 607, and a delivery date and time (end) 608.

The order number 601 represents an identification number of an order. The cargo pickup source code 602 represents an identification code of a point of a cargo pickup source. The delivery destination code 603 represents an identification code of a point of a delivery destination. The number 604 represents the number of pieces of cargo. The cargo pickup date and time (start) 605 and the cargo pickup date and time (end) 606 represent a start date and time and an end date and time of a period in which cargo pickup is possible. The delivery date and time (start) 607 and the delivery date and time (end) 608 represent a start date and time and an end date and time of a period in which delivery is possible. A value of the number 604 may be an example of a value of a cargo volume. The value of the cargo volume may be expressed based on at least one of a value of a total weight of cargo and a value of a total volume of the cargo instead of or in addition to the number of pieces of cargo. Expressions of the period in which cargo pickup is possible and the period in which delivery is possible may be expressions in a combination of a start date and time and a period length from the start date and time.

FIG. 7 is a table illustrating an example of a data structure of the vehicle information 114 according to the embodiment.

The vehicle information 114 includes entries for each vehicle. The entries include information such as a vehicle name 701, a number of loads upper limit 702, a vehicle unit price 703, an operation unit price 704, a charging amount upper limit 705, a charging amount lower limit 706, and electricity consumption 707.

The vehicle name 701 represents an identification name of a vehicle. The number of loads upper limit 702 represents a number of loads upper limit of the vehicle (for example, an upper limit of the number of pieces of cargo). The vehicle unit price 703 represents a handling charge required for one vehicle. The operation unit price 704 represents a use charge of the vehicle required for an operation unit time of the vehicle. The charging amount upper limit 705 represents an upper limit of a charging amount to the vehicle. The charging amount lower limit 706 represents a lower limit of the charging amount to the vehicle. The electricity consumption 707 represents electricity consumption of the vehicle. A value of the number of loads upper limit 702 may be expressed based on at least one of an upper limit value of a weight that can be loaded and an upper limit value of a volume that can be loaded instead of or in addition to an upper limit value of the number of pieces of cargo that can be loaded. The entries may include information such as a “driver unit price” representing personal expenses of a driver per operation unit time of the vehicle or may include information such as a “carbon dioxide emission unit price” representing a carbon dioxide emission amount per unit consumption amount of electric power instead of or in addition to at least a part of the information 702 to 707.

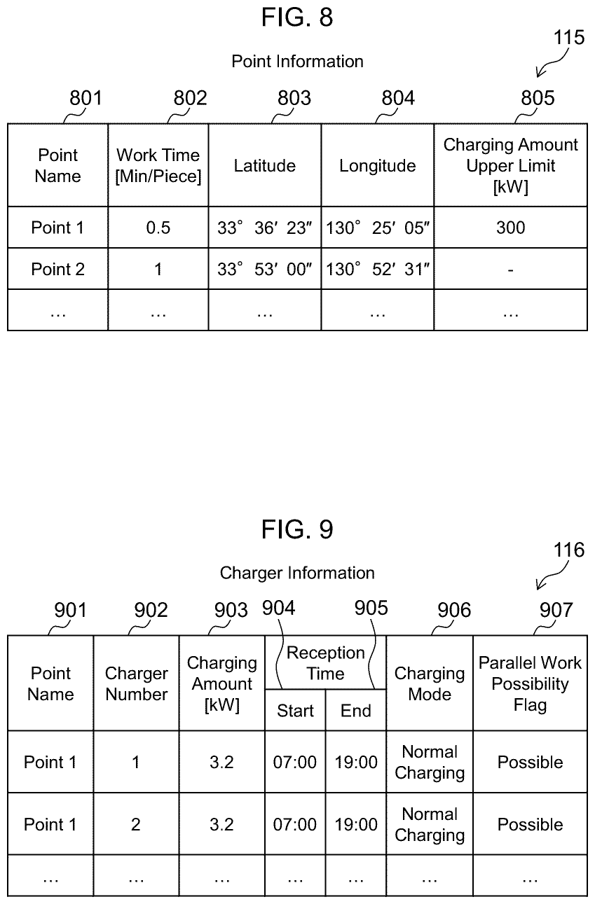

FIG. 8 is a table illustrating an example of a data structure of the point information 115 according to the embodiment.

The point information 115 includes entries for each point. The entries include information such as a point name 801, a work time 802, a latitude 803, a longitude 804, and a charging amount upper limit 805.

The point name 801 represents an identification name of a point. The work time 802 represents a work time that is a time required for work (loading or unloading) per piece of cargo at the point. The latitude 803 represents the latitude of the point and the longitude 804 represents the longitude of the point. The charging amount upper limit 805 represents an upper limit of a chargeable electricity amount per unit time at the point. The work time 802 may be divided into information such as a “loading time” representing a time required for loading per piece of cargo and information such as an “unloading time” representing a time required for unloading per piece of cargo. Further, the entries may include information such as “power consumption of a building” representing power consumption of a building at the point instead of or in addition to at least a part of information 802 to 805.

FIG. 9 is a table illustrating an example of a data structure of the charger information 116 according to the embodiment.

The charger information 116 includes entries for each charger. The entries include information such as a point name 901, a charger number 902, a charging amount 903, a reception time (start) 904, a reception time (end) 905, a charging mode 906, and a parallel work possibility flag 907.

The point name 901 represents an identification name of a point. The charger number 902 represents an identification number of a charger present at the point. The charging amount 903 represents a charging amount per unit time chargeable using the charger. The reception time (start) 904 represents a start date and time of a time period in which the charger is usable. The reception time (end) 905 represents an end date and time of the time period. The charging mode 906 represents a charging mode usable in the charger. The parallel work possibility flag 907 represents whether work of charging and loading or unloading can be performed in parallel at the point. The entries may further include information such as an “electricity charge” representing an electricity charge required for charging per unit time.

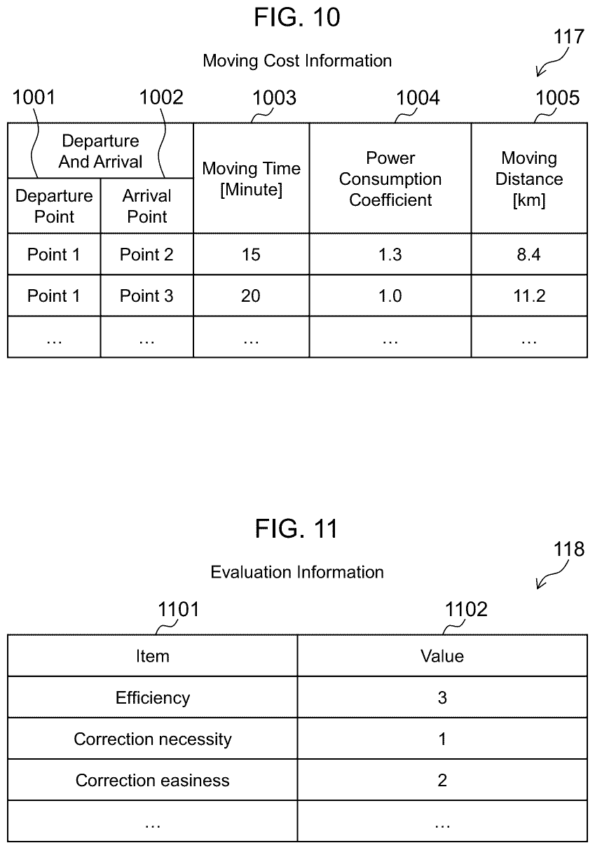

FIG. 10 is a table illustrating an example of a data structure of the moving cost information 117 according to the embodiment.

The moving cost information 117 includes entries for each set of a departure point and an arrival point. The entries include information such as a departure point 1001, an arrival point 1002, a moving time 1003, a power consumption coefficient 1004, and a moving distance 1005.

The departure point 1001 represents an identification name of a departure point (a moving source point). The arrival point 1002 represents an identification name of an arrival point (a moving destination point). The moving time 1003 represents a moving time from the departure point to the arrival point. The power consumption coefficient 1004 represents a ratio of the magnitude of power consumption by the movement from the departure point to the arrival point. The moving distance 1005 represents a moving distance from the departure point to the arrival point.

FIG. 11 is a table illustrating an example of a data structure of the evaluation information 118 according to the embodiment.

The evaluation information 118 includes entries for each evaluation item. The entries include information such as an item 1101 representing an item name of an evaluation item and a value 1102 representing an evaluation value corresponding to the evaluation item. “Efficiency” is efficiency of transportation, “correction necessity” is necessity of schedule correction, and “correction easiness” is easiness of schedule correction.

In S200 in FIG. 3, the prediction error calculation unit 131 calculates a buffer value used in schedule planning using the prediction result information 111, the order information 113, the vehicle information 114, the point information 115, the charger information 116, and the moving cost information 117 and stores the buffer value in the parameter information 112.

In the prediction result information 111, the prediction score 403 is a prediction parameter value calculated by a predetermined method for a prediction parameter name represented by the item 402. For example, the prediction score 403 for the item 402 “power consumption of a building” is set to maximum power consumption at a schedule target date and time represented by the date 401. The error 404 is a difference between the prediction score 403 and a result value calculated by the same method as the method of calculating the prediction score 403. The prediction error calculation unit 131 determines a buffer value of the prediction score 403 based on a set of the prediction score 403 and the error 404 and at least a part of information in the order information 113, the vehicle information 114, the point information 115, the charger information 116, and the moving cost information 117. The input unit 140 may receive at least one of weather information (for example, information representing weather at points in a period including a schedule target date and time) and congestion information (for example, information representing a degree of congestion between points in the period including the schedule target date and time) from an external source. The prediction error calculation unit 131 may determine a buffer value making use of at least one of the weather information and the congestion information besides the set of the prediction score 403 and the error 404 and at least a part of the information in the order information 113, the vehicle information 114, the point information 115, the charger information 116, and the moving cost information 117.

In S300, the schedule planning unit 132 plans a transportation schedule plan and a charging schedule plan based on at least a part of the parameter information 112, the order information 113, the vehicle information 114, the point information 115, the charger information 116, and the moving cost information 117 and stores the transportation schedule plan in the transportation schedule plan information 119 and stores the charging schedule plan in the charging schedule plan information 120. As a constraint parameter name of the parameter information 112, for example, at least one of “a use time upper limit of a quick charger”, “a lower limit of a time in which a vehicle stays at a point without being charged”, “peak power”, “a number of simultaneously staying vehicles upper limit in business”, “an upper limit of the number of vehicles having a large ratio of a traveling distance to a cruising distance”, “an upper limit of the number of consecutive operations with a short workable time frame”, and “a lower limit of a difference between work end hour and a work time limit” may be adopted. For example, when the value 502 of the item 501 “peak power” is “240 kW”, a schedule plan has to be planned such that peak power is 240 kW or less even if the charging amount upper limit 805 stored in the point information 115 is “300 kW”.

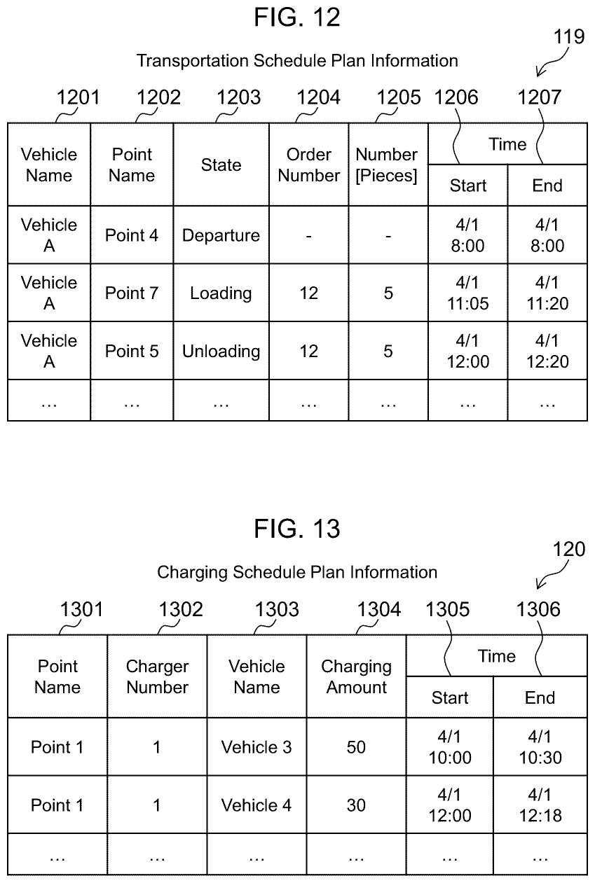

FIG. 12 is a table illustrating an example of a data structure of the transportation schedule plan information 119 according to the embodiment.

The transportation schedule plan information 119 includes information representing one or a plurality of transportation schedule plans. The transportation schedule plan information 119 illustrated in FIG. 12 represents one transportation schedule plan. The information representing the transportation schedule plan includes entries for each event relating to transportation. The entries include information such as a vehicle name 1201, a point name 1202, a state 1203, an order number 1204, a number 1205, a time (start) 1206, and a time (end) 1207.

The vehicle name 1201 represents an identification name of a vehicle. The point name 1202 represents an identification name of a point. The state 1203 represents work performed at the point. The order number 1204 represents an identification number of an order of a work target. The number 1205 represents the number of pieces of cargo of work targets. The time (start) 1206 represents a start date and time of a time when work is performed. The time (end) 1207 represents an end date and time of the time when the work is performed. A value of the number 1205 may be an example of a value of a cargo volume like the value of the number 604. The value of the cargo volume may be expressed based on at least one of a value of a total weight of cargo and a value of a total volume of the cargo instead or in addition to the number of pieces of cargo.

FIG. 13 is a table illustrating an example of a data structure of the charging schedule plan information 120 according to the embodiment.

The charging schedule plan information 120 includes information representing one or a plurality of charging schedule plans. The charging schedule plan information 120 illustrated in FIG. 13 represents one charging schedule plan. The information representing the charging schedule plan includes entries for each event relating to charging. The entries include information such as a point name 1301, a charger number 1302, a vehicle name 1303, a charging amount 1304, a time (start) 1305, and a time (end) 1306.

The point name 1301 represents an identification name of a charging point. The charger number 1302 represents an identification number of a charger at a point. The vehicle name 1303 represents an identification name of a vehicle to be charged. The charging amount 1304 represents a charging amount per unit time. The time (start) 1305 represents a start date and time of a time when charging work is performed and the time (end) 1306 represents an end date and time of the time. For example, when a charger number is the same among all points, the entries may not include the point name 1301.

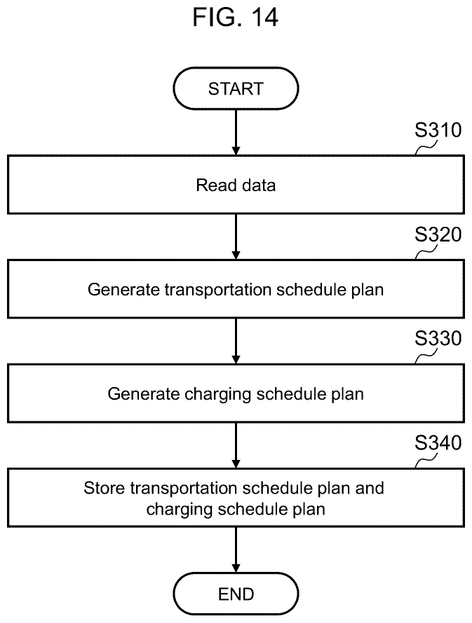

FIG. 14 is a flowchart illustrating an example of schedule planning processing according to the embodiment.

When the processing is started, the schedule planning unit 132 reads the parameter information 112, the order information 113, the vehicle information 114, the point information 115, the charger information 116, and the moving cost information 117 (S310).

The schedule planning unit 132 generates a transportation schedule plan according to a constraint parameter value combination in the parameter information 112 read in S310 (S320). A plurality of transportation schedule plans may be generated for one constraint parameter value combination. The transportation schedule plan is generated by, for example, an all-kinds search or a simulation.

The schedule planning unit 132 generates, according to the constraint parameter value combination in the parameter information 112 read in S310, a charging schedule plan for performing charging a vehicle in a time when the vehicle is staying at a chargeable point among the plurality of points represented by the transportation schedule plan generated in S320 (S330). A plurality of charging schedule plans may be generated for one transportation schedule plan. The charging schedule plan is generated by, for example, an all-kinds search or a simulation.

The schedule planning unit 132 stores the transportation schedule plan generated in S320 in the transportation schedule plan information 119 and stores the charging schedule plan generated in S330 in the charging schedule plan information 120 (S340). In the transportation schedule plan information 119, for each transportation schedule plan, information for identifying a charging schedule plan corresponding to the transportation schedule plan may also be stored, and/or, in the charging schedule plan information 120, for each charging schedule plan, information for identifying a transportation schedule plan corresponding to the charging schedule plan may be stored.

Referring back to FIG. 3, in S400, the evaluation unit 133 performs schedule evaluation processing using the vehicle information 114, the point information 115, the evaluation information 118, and the one schedule plan combination generated in S300 (a combination of a transportation schedule plan and a charging schedule plan corresponding to the transportation schedule plan). As a value of the item 1101 of the evaluation information 118, at least “efficiency” representing efficiency in a schedule and “correction easiness” representing easiness of schedule correction are adopted. As the value of the item 1101, “correction necessity” representing necessity of schedule correction may be further adopted.

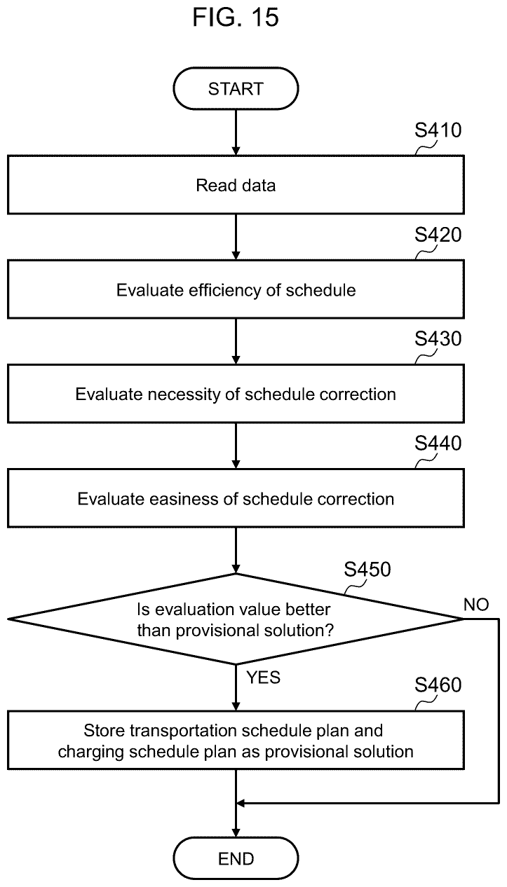

FIG. 15 is a flowchart illustrating an example of the schedule evaluation processing according to the embodiment.

When the processing is started, the evaluation unit 133 reads the vehicle information 114, the point information 115, the evaluation information 118, and one of transportation schedule plans stored in the transportation schedule plan information 119, and one of charging schedule plans stored in the charging schedule plan information 120 (S410). The transportation schedule plan and the charging schedule plan to be read are plans corresponding to each other.

The evaluation unit 133 evaluates efficiency of a schedule (S420). For example, the evaluation unit 133 evaluates the efficiency based on at least one of the number of vehicles running short of residual electric energy or running out of electricity, a cargo volume that cannot be transported, the number of vehicles to be used, a transportation expense, a transportation time, a power consumption amount by transportation, an electric power fee required for charging, and a carbon dioxide amount emitted by transportation. Specifically, for example, the evaluation unit 133 can calculate the number of vehicles running short of residual electric energy or running out of electricity by counting the number of vehicles having the residual electric energy equal to or smaller than a threshold using the evaluation information 118, the transportation schedule plan information 119, and the charging schedule plan information 120. The efficiency of the schedule is calculated using a weighted sum, for example, as indicated by the following Expression (1).

$$Efficiency = ( weight α \times the number of vehicles running short of residual electric energy or running out of electricity ) \times ( weight β \times a cargo volume that cannot be transported ) \times ( weight γ \times a transportation expense ) \times ( weight δ \times an electric power fee required for charging ) \qquad 〈 Expression ( 1 ) 〉$$

Here, the weights may be stored in the evaluation information 118. The weights may be values specifically set for the schedule planning apparatus 100.

The evaluation unit 133 evaluates necessity of schedule correction (S430). For example, the evaluation unit 133 evaluates the necessity of the schedule correction based on at least one of a tolerance of a prediction error of power consumption of a building, a tolerance of a prediction error of a demand target, a tolerance of a prediction error of residual electric energy at a start time, a tolerance of a prediction error of electricity consumption, a tolerance of a prediction error of power consumption cost between points, a tolerance of a prediction error of delivery hour, and a tolerance of a prediction error of a cargo volume. Specifically, for example, the tolerance of the prediction error of the electricity consumption can be specified by calculating, using the vehicle information 114, the transportation schedule plan information 119, and the charging schedule plan information 120, up to which increased degree of a ratio of the electricity consumption, a vehicle can be operated without correcting the transportation schedule plan information 119 and the charging schedule plan information 120.

The necessity of the schedule correction is calculated using a weighted sum, for example, as indicated by the following Expression (2).

$$Correction necessity = ( weight ε \times a buffer value of a prediction error of a demand target ) \times ( weight ξ \times a buffer value of a prediction error of electricity consumption ) \times ( weight η \times a buffer value of a prediction error of a cargo volume ) \qquad 〈 Expression ( 2 ) 〉$$

Here, the weights may be stored in the evaluation information 118. The weights may be values specifically set for the schedule planning apparatus 100.

The evaluation unit 133 evaluates easiness of schedule correction (S440). For example, the evaluation unit 133 evaluates easiness of schedule correction based on at least one of a total use time of a quick charger, a time in which a vehicle is staying at a point without being charged, a difference between contracted power and prediction peak power, a maximum number of simultaneously staying vehicles in business, the number of vehicles having a large ratio of a traveling distance to a cruising distance, a maximum value of the number of consecutive operations with a short workable time frame, and the magnitude of a difference between work end hour and a work time limit. Specifically, for example, the total use time of the quick charger can be specified using the charger information 116 and the charging schedule plan information 120. The easiness of the schedule correction is calculated using a weighted sum, for example, as indicated by the following Expression (3).

$$Correction easiness = ( weight θ \times a total use time of a quick charger ) \times ( weight ι \times a maximum number of simultaneously staying vehicles in business ) \times ( weight κ \times the number of vehicles having a large ratio of a traveling distance to a cruising distance ) \times ( weight λ \times the magnitude of a difference between work end hour and a work time limit ) \qquad 〈 Expression ( 3 ) 〉$$

Here, the weights may be stored in the evaluation information 118. The weights may be values specifically set for the schedule planning apparatus 100.

The evaluation unit 133 calculates an evaluation value of a schedule using a weighted sum as indicated by the following Expression (4) using the evaluation information 119, the evaluation value of the efficiency calculated in S420, the evaluation value of the correction necessity calculated in S430, and the evaluation value of the correction easiness calculated in S440 and determines whether the evaluation value is better than an evaluation value serving as a provisional solution (S450). When determining that the evaluation value is a better evaluation value (the evaluation value is better than the provisional solution) (S450: YES), the evaluation unit 133 stores a combination of a transportation schedule plan and a charging schedule plan as the provisional solution (S460). In Expression (4), a “parameter value” may be a value representing a level of an evaluation value and may be, for example, a value after normalization of the evaluation value. In Expression (4), weight may be adopted instead of or in addition to one of the evaluation value and the parameter value.

$$Schedule evaluation value = ( an efficiency parameter value \times an evaluation value of efficiency ) \times ( a correction necessity parameter value \times an evaluation value of correction necessity ) \times ( a correction easiness parameter value \times an valuation value of correction easiness ) \qquad 〈 Expression ( 4 ) 〉$$

Referring back to FIG. 3, lastly, in S500, the display unit 150 outputs the provisional solution. The communication unit 160 transmits, via the network 51, information for vehicle (for example, information including a transportation schedule) to the in-vehicle terminal 200, transmits information for point (for example, information including the transportation schedule and a charging schedule) to the point schedule management terminal 300, and transmits the charging schedule to the charging control apparatus 400.

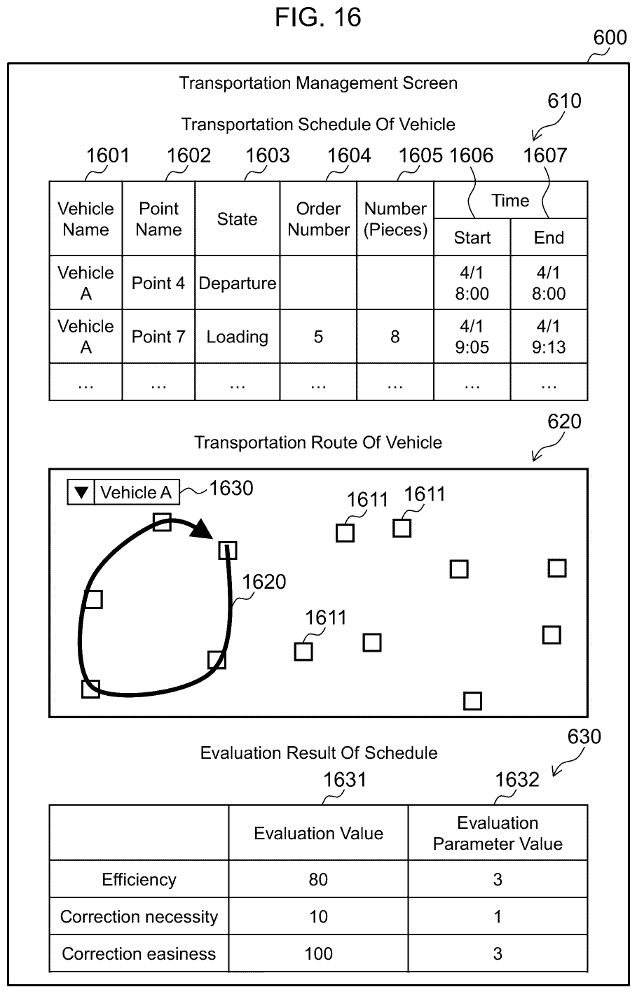

FIG. 16 is a diagram illustrating an example of a transportation management screen 600 according to the embodiment.

The transportation management screen 600 is displayed on the display apparatus 450. The transportation management screen 600 includes information such as a vehicle transportation schedule 610, a vehicle transportation route 620, and a schedule evaluation result 630. A transportation schedule and a result of evaluation for the transportation schedule can be checked from the transportation management screen 600.

The vehicle transportation schedule 610 represents a transportation schedule in a best schedule combination (for example, a schedule combination (a transportation schedule and a charging schedule corresponding to each other) having the highest total of the evaluation value 1631 or the evaluation parameter value 1632).

Specifically, for example, a vehicle name 1601, a point name 1602, a state 1603, an order number 1604, a number 1605, a time (start) 1606, and a time (end) 1607 are displayed for each event concerning transportation. The information 1601 to 1607 corresponds to the information 1201 to 1207 of the transportation schedule plan information 119. Further, a transportation amount of an order may be displayed. The state 1603 may be at least any one of departure, loading, unloading, charging, and arrival. The transportation amount may be displayed. The transportation amount may be based on the number of pieces of cargo, a total weight, a total volume, or a combination thereof. The time (start) 1606 and the time (end) 1607 may be a time period in which a vehicle stays at a point instead of a time period in which work is performed. The transportation schedule may be visualized by a Gantt chart in which the horizontal axis indicates hour and the vertical axis indicates vehicles (not illustrated).

The vehicle transportation route 620 may represent a transportation route for each vehicle or may represent a vehicle transportation route 1620 selected using a tool such as a pulldown menu 1630. In FIG. 16, the transportation route 1620 is a transportation route of a vehicle A. The vehicle transportation route 620 may include objects 1611 representing points. The positions of the objects 1611 at the points may be decided based on the latitude 803 and the longitude 804 in the point information 115. The transportation route for each vehicle is specified based on the vehicle name 1201, the point name 1202, and the state 1203 of the entries of the transportation schedule plan information 119.

The schedule evaluation result 630 represents evaluation results of efficiency, correction necessity, and correction easiness of the displayed transportation schedule (the best schedule combination). For the evaluation items, at least one of the evaluation value 1631 and the evaluation parameter value 1632 may be displayed. For each evaluation item, a value of the evaluation value 1631 and a value of the evaluation parameter value 1632 may be values used in Expression (4) described above. Further, at least one of total transportation cost, a total transportation distance, a total transportation time, and a total power consumption amount may be displayed.

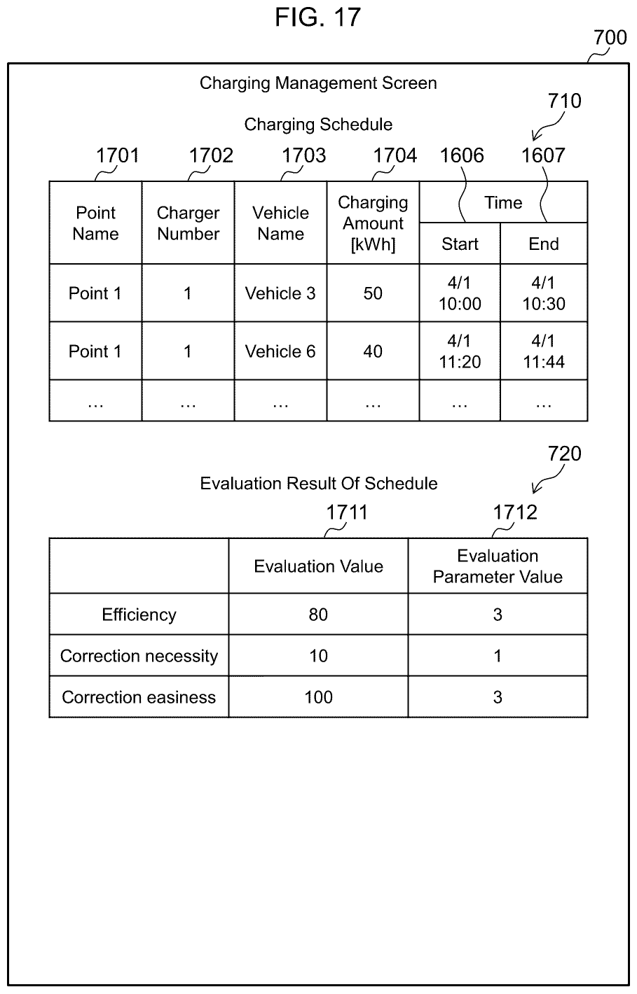

FIG. 17 is a diagram illustrating an example of a charging management screen 700 according to the embodiment.

The charging management screen 700 is displayed on the display apparatus 450. The charging management screen 700 includes a charging schedule 710 and a schedule evaluation result 720. A charging schedule and a result of evaluation for the charging schedule can be checked from the charging management screen 700.

The charging schedule 710 represents a charging schedule in the best schedule combination. Specifically, for each event concerning charging, a point name 1701 (an identification name of a charging point), a charger number 1702, a vehicle name 1703, a charging amount 1704, a time (start) 1705, and a time (end) 1706 are displayed. The information 1701 to 1706 corresponds to the information 1301 to 1306 of the charging schedule plan information 120.

The schedule evaluation result 720 represents an evaluation result of the displayed charging schedule (best schedule combination). The information 1711 and 1712 is the same as the information 1631 and 1632 in the evaluation result 630 illustrated in FIG. 16.

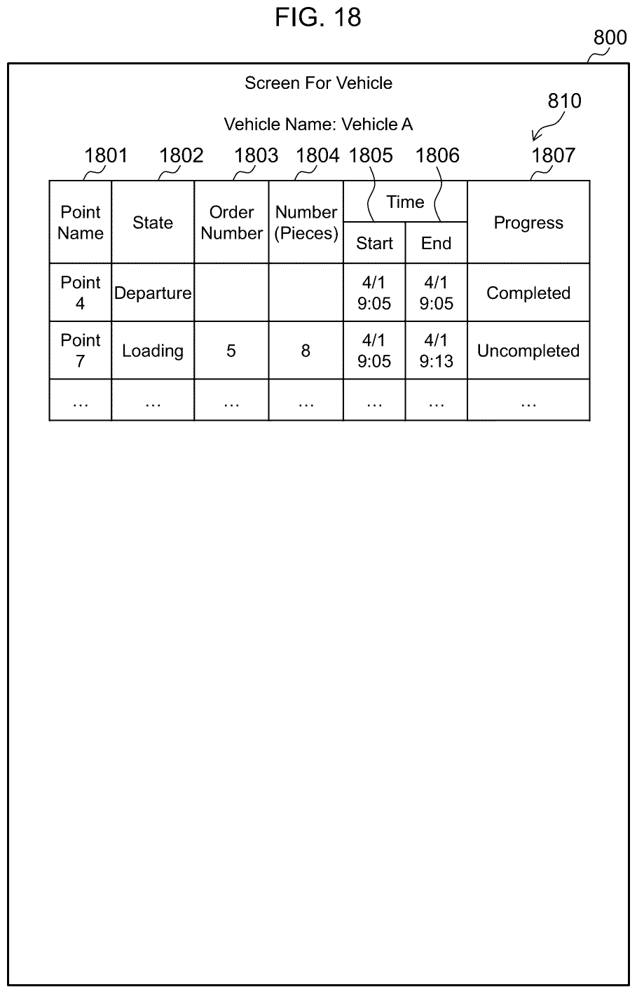

FIG. 18 is a diagram illustrating an example of a screen for vehicle 800 according to the embodiment.

On the screen for vehicle 800, a transportation schedule of the vehicle 510 including the in-vehicle terminal 200 to which the screen for vehicle 800 is provided is displayed. Specifically, for each event relating to transportation, information 1801 to 1806 concerning the vehicle 510 and a progress 1807 that is information representing a progress of work represented by a state 1802 are displayed. A transportation schedule and a transportation progress situation can be checked from the screen for vehicle 800. The information 1801 to 1806 is the same as the information 1602 to 1607 illustrated in FIG. 16. A charging schedule of the vehicle 510 may be further displayed on the screen for vehicle 800. A value of the progress 1807 may be automatically updated according to a situation detected by the in-vehicle terminal 200 or may be manually updated.

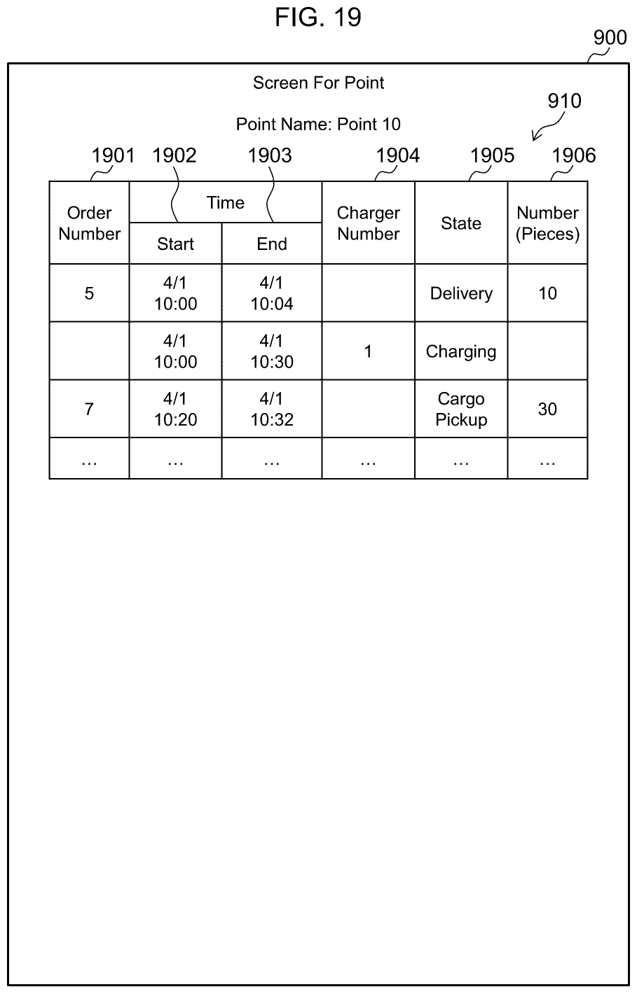

FIG. 19 is a diagram illustrating an example of a screen for point 900 according to the embodiment.

On the screen for point 900, a schedule of work relating to transportation and charging performed at the point 520 is displayed. Specifically, for each event concerning transportation or charging, an order number 1901 (an identification number of an order of a work target), a time (start) 1902 and a time (end) 1903 (a time period of work), a charger number 1904 (an identification number of a charger), a state 1905 (a type of the work), and a number 1906 (the number of pieces of cargo) are displayed. The information 1901 to 1906 is based on, of the transportation schedule plan information 119 and the charging schedule plan information 120, information included in an entry corresponding to the point 520. A value of the state 1905 may be at least any one of cargo pickup, delivery, and charging. A schedule of cargo pickup and delivery work and a schedule of charging may be separately displayed. A person in charge of schedule operation and a worker can check, from the screen for point 900, a schedule of work relating to transportation and charging performed at points.

The schedule planning system according to the embodiment of the present invention is explained above. With the schedule planning system explained above, in a transportation job by a motor-driven vehicle, it is possible to improve efficiency and reduce correction man-hours of the person in charge of schedule operation by adopting a schedule having easiness instead of a schedule without necessity of schedule correction.

The embodiment of the present invention is explained above. However, the embodiment is presented as an example and is not intended to limit the scope of the invention. The invention can be carried out in other various forms. Various omissions, substitutions, and changes can be made without departing from the gist of the invention. The embodiment is included in the scope and the gist of the invention and included in the inventions described in the claims and a scope of equivalents of the inventions. For example, a transportation schedule and a charging schedule may be time-series events (for example, what performs what kind of a thing and where and from when to when) in a schedule target period (for example, a time period, a day, or a week).

For example, the above explanation can be summarized as follows. Note that the following summarization may include supplementary explanation of the above explanation and explanation of modifications.

The schedule planning apparatus 100 includes the input unit 140, the schedule planning unit 132, the evaluation unit 133, and the output unit 141.

A plurality of parameter values is input to the input unit 140. The plurality of parameter values is used for planning of a schedule combination. The schedule combination includes a transportation schedule and a charging schedule based on the transportation schedule. The transportation schedule is a schedule for transporting a plurality of pieces of cargo to a plurality of points with a plurality of transportation vehicles. The “plurality of transportation vehicles” include a plurality of motor-driven vehicles that require charging. The plurality of transportation vehicles may include a transportation vehicle other than the motor-driven vehicles that require charging. The charging schedule includes a schedule for charging for the plurality of motor-driven vehicles.

The schedule planning unit 132 plans one or a plurality of schedule combinations based on the input plurality of parameter values.

The evaluation unit 133 evaluates, for each of the planned one or plurality of schedule combinations, efficiency (efficiency of transportation) and correction easiness (easiness of schedule correction). For example, the evaluation unit 133 calculates, for each of the planned one or plurality of schedule combinations, an evaluation value for each of the efficiency and the correction easiness.

The output unit 141 outputs information based on at least a part of a target schedule combination among the one or the plurality of schedule combinations. The target schedule combination is a schedule combination in which the efficiency and the correction easiness are relatively high.

The plurality of parameter values used for planning a schedule combination include a plurality of prediction parameter values and one or a plurality of kinds of constraint parameter value combinations. The prediction parameter values are prediction values for parameter names. One or a plurality of constraint parameter values are present for each of a plurality of constraint parameter names. For each of the one or the plurality of kinds of constraint parameter value combinations, the constraint parameter value combination is a combination including a plurality of constraint parameter values respectively corresponding to the plurality of constraint parameter names. A constraint parameter value of at least one constraint parameter name affects the correction easiness (an evaluation value of the correction easiness).

As explained above, an evaluation item (an evaluation viewpoint) called correction easiness is prepared, a constraint parameter name affecting the correction easiness is prepared, and one or a plurality of kinds of constraint parameter value combinations are included in a plurality of parameter values used for planning a schedule combination. Accordingly, it is easy to perform schedule correction even if the schedule correction is necessary and it is possible to expect that a transportation schedule and a charging schedule having high transportation efficiency can be provided.

Note that the “plurality of parameter values” may include, as parameter values, at least a part of information elements among cargo information (for example, the order information 113) concerning pieces of cargo to be transported, the vehicle information 114 concerning a plurality of transportation vehicles, the point information 115 (which may include, for example, information concerning movement between points) concerning points serving as a moving source/a moving destination (for example, a departure point, an arrival point, a relay point, and a charging point) of a transportation vehicle, and the charger information 116 concerning a charger installed at a point where charging is possible and capable of charging a motor-driven vehicle.

The “efficiency” may be, for example, that transportation can be performed without waste. As elements affecting the efficiency, at least one of the following may be adopted:
Whether the number of vehicles is small (for example, it is desirable to avoid planning a schedule with a large number of vehicles and planning a schedule in which a motor-driven vehicle that cannot transport all cargo or runs out of electricity occurs and a new transportation vehicle is required in a schedule target day (the day)).
Whether expenses required for transportation are small.
Whether electric energy and an electric power fee consumed in the transportation are small.
Whether the amount of carbon dioxide emitted in the transportation is small.

The “correction easiness” may be with how few man-hours a planned schedule can be corrected (how small a correction cost may be). As elements affecting the correction easiness, at least one of the following may be adopted, and the “correction cost” may be based on man-hours required for correction, a time required for correction, or a combination thereof:
Whether only a charging schedule may be corrected without a transportation schedule being corrected.
Whether a relation between a transportation vehicle and a piece of cargo to be transported does not need to be corrected.

The evaluation unit 133 may evaluate, for each of the one or the plurality of schedule combinations, besides the efficiency and the correction easiness, correction necessity that is necessity of schedule correction. The plurality of parameter values may include a buffer value correlated with each of one or more prediction parameter values among a plurality of prediction parameter values. At least one buffer value may affect the correction necessity. The target schedule combination may be a schedule combination in which the efficiency and the correction easiness are relatively high and the correction necessity is relatively low. Accordingly, it is possible to provide a schedule combination in which correction cost for a schedule may be small even if schedule correction is necessary because the efficiency is high and the correction necessity is low but an error exceeding the buffer value has occurred or because of other causes.

Note that the “correction necessity” may be that, no matter how large a prediction error occurs, a schedule does not need to be corrected. As elements affecting the correction necessity, at least one of the following may be adopted:
Can transportation be continued without a planned schedule being corrected no matter how much more a cargo volume increases than expected?
Can transportation be continued without a planned schedule being corrected no matter how much more power consumption of a building increases than expected?

The one or more prediction parameter values respectively correlated with buffer values may be at least one of power consumption of a building at a point where charging can be performed, a demand target, residual electric energy of a motor-driven vehicle at a transportation start time, electricity consumption (a distance travelable per unit electric energy), power consumption between points, a departure date and time of the point, an arrival date and time of the point, and a cargo volume. Accordingly, improvement of evaluation accuracy of the correction necessity is expected.

The schedule planning unit 132 may plan one or a plurality of schedule combinations for each of the one or the plurality of kinds of constraint parameter value combinations. Accordingly, at least one schedule combination is planned for each constraint parameter value combination. It is expected that planned schedule combinations are schedule combinations having high efficiency and correction easiness in a range conforming to constraint parameter value combinations corresponding to the schedule combinations.

The plurality of constraint parameter values may include one or a plurality of first constraint parameter values affecting correction cost of a charging schedule in order to preferentially correct a charging schedule to reduce correction cost of a transportation schedule as much as possible when it is necessary to correct a schedule combination. Accordingly, even if schedule correction is necessary, it can be expected that the schedule correction is performed with small correction cost without deteriorating efficiency conforming to the transportation schedule as much as possible.

Note that the one or the plurality of first constraint parameter values may include at least one of an upper limit value of a total use time of a charger, a charging mode of which is quick, a lower limit value of a total time of staying times of one or more vehicles staying at a point without being charged, a lower limit value of a difference between a demand target and predicted peak power, an upper limit value of the number of vehicles simultaneously staying at one point during business hours, and an upper limit value of the number of motor-driven vehicles, a ratio of a traveling distance of which to a cruising distance is equal to or larger than a threshold. Accordingly, improvement of evaluation accuracy of correction easiness is expected. For example, a schedule combination may be planned or an evaluation value of correction easiness may be calculated based on a difference between a constraint parameter value and a parameter value of the same parameter name as a constraint parameter name. For example, at least one of the following may have a tendency that an evaluation value of correction easiness is high:
That a total time of staying times of one or more vehicles staying at a point without being charged is long.
That a total use time of a quick charger is short.
That a difference between a demand target and predicted peak power is large.
That the number of vehicles simultaneously staying at one point during business hours is small.
That the number of motor-driven vehicles, a ratio of a traveling distance of which to a cruising distance is equal to or larger than a threshold, is small.

The plurality of constraint parameter values may include one or a plurality of second constraint parameter values affecting correction cost of a transportation schedule. The one or the plurality of second constraint parameter values may include at least one of an upper limit value of the number of consecutive operations in which the length of a cargo pickup or delivery time frame is equal to or smaller than a threshold, and a lower limit value of a difference between an end date and time of cargo pickup or delivery work and a cargo pickup or delivery time limit. Accordingly, a schedule combination in which a transportation schedule can be corrected with small correction cost even if schedule correction is necessary is expected. For example, at least one of the following may have a tendency that correction cost of a transportation schedule is small:
That the number of consecutive operations in which the length of a cargo pickup or delivery time frame is equal to or smaller than a threshold is small.
That a difference between an end date and time of cargo pickup or delivery work and a cargo pickup or delivery time limit is large.

One or more parameter values included in the plurality of parameter values or obtained from at least a part of the plurality of parameter values and affecting efficiency may be at least one of the number of motor-driven vehicles running short of residual electric energy or running out of electricity, a cargo volume that cannot be transported, the number of vehicles to be used, a transportation expense, a transportation time, a power consumption amount by transportation, a carbon dioxide emission amount by the transportation, and an electric power fee required for charging. Accordingly, improvement of evaluation accuracy of efficiency is expected.

The target schedule combination may be a schedule combination in which the efficiency and the correction easiness (for example, evaluation values thereof) are Pareto optimum or a schedule combination in which evaluation of the efficiency and the correction easiness is the best (for example, a schedule combination in which a schedule evaluation value determined based on the evaluation values thereof is the best). Accordingly, it is expected that a schedule combination preferable from the viewpoint of at least the efficiency and the correction easiness is adopted.

The output unit 141 may perform at least one of (a) to (d) described below. Accordingly, it is possible to provide optimum information to an output destination. For example, with (d), automatic charging control conforming to a charging schedule is expected.
(a) The output unit 141 displays, on the display apparatus 450 or a remote computer, a transportation schedule and/or a charging schedule in the target schedule combination.
(b) The output unit 141 transmits, for at least one transportation vehicle among the plurality of transportation vehicles, to an information processing terminal present in the transportation vehicle, information representing a transportation schedule portion and/or a charging schedule portion corresponding to the transportation vehicle in the target schedule combination. The “information processing terminal” may be, for example, an in-vehicle apparatus of the transportation vehicle or a mobile terminal carried by a person riding on the transportation vehicle.
(c) The output unit 141 transmits, for at least one point among the plurality of points, to an information processing terminal present at the point, information representing a transportation schedule portion and/or a charging schedule portion corresponding to the point in the target schedule combination. The “information terminal” may be, for example, a stationary or mobile personal computer or a smartphone at the point.
(d) The output unit 141 transmits, for at least one chargeable point among the plurality of points, to a charging control apparatus that controls a charger present at the point, charging control information conforming to a charging schedule portion corresponding to the point in the target schedule combination. The “charging control information” may be information concerning how much charging is performed on which charger and when or may be a control command transmitted according to the charging schedule portion.

Note that the functions such as the input unit 140, the prediction error calculation unit 131, the schedule planning unit 132, the evaluation unit 133, and the output unit 141 may be present in one apparatus or may be distributed to a plurality of apparatuses. For example, there may be a first apparatus including the functions such as the input unit 140, the prediction error calculation unit 131, and the schedule planning unit 132 and a second apparatus including the functions such as the evaluation unit 133 and the output unit 141. The first apparatus may output information representing one or a plurality of planned schedule combinations. The second apparatus may evaluate each of the one or the plurality of schedule combinations represented by the information and output information based on an evaluation result.

1. A schedule planning apparatus comprising:
an input unit configured to receive input of a plurality of parameter values used for planning of a schedule combination including a transportation schedule for transporting a plurality of pieces of cargo to a plurality of points with a plurality of transportation vehicles including a plurality of motor-driven vehicles that require charging and a charging schedule that is a schedule for charging the plurality of motor-driven vehicles and is based on the transportation schedule;
a schedule planning unit configured to plan one or a plurality of schedule combinations based on the plurality of parameter values;
an evaluation unit configured to evaluate, for each of the one or the plurality of schedule combinations, efficiency that is efficiency of transportation and correction easiness that is easiness of schedule correction; and
an output unit configured to output information based on at least a part of a target schedule combination, wherein
the plurality of parameter values includes a plurality of prediction parameter values and one or a plurality of kinds of constraint parameter value combinations,
the prediction parameter values are prediction values for parameter names,
one or a plurality of constraint parameter values are present for each of a plurality of constraint parameter names,
for each of the one or the plurality of kinds of constraint parameter value combinations, the constraint parameter value combination is a combination including a plurality of constraint parameter values respectively corresponding to the plurality of constraint parameter names,
a constraint parameter value of at least one constraint parameter name affects the correction easiness, and
the target schedule combination is a schedule combination in which the efficiency and the correction easiness are relatively high.

2. The schedule planning apparatus according to claim 1, wherein
the evaluation unit evaluates, for each of the one or the plurality of schedule combinations, besides the efficiency and the correction easiness, correction necessity that is necessity of schedule correction,
the plurality of parameter values includes a buffer value correlated with each of one or more prediction parameter values among the plurality of prediction parameter values,
at least one buffer value affects the correction necessity, and
the target schedule combination is a schedule combination in which the efficiency and the correction easiness are relatively high and the correction necessity is relatively low.

3. The schedule planning apparatus according to claim 2, wherein the one or more prediction parameter values respectively correlated with buffer values are at least one of power consumption of a building at a point where charging can be performed, a demand target, residual electric energy of a motor-driven vehicle at a transportation start time, electricity consumption, power consumption between points, a departure date and time at a point, an arrival date and time at the point, and a cargo volume.

4. The schedule planning apparatus according to claim 1, wherein the schedule planning unit plans one or a plurality of schedule combinations for each of the one or the plurality of kinds of constraint parameter value combinations.

5. The schedule planning apparatus according to claim 1, wherein the plurality of constraint parameter values includes one or a plurality of first constraint parameter values that affect correction cost of a charging schedule in order to preferentially correct a charging schedule to reduce correction cost of a transportation schedule as much as possible when it is necessary to correct a schedule combination.

6. The schedule planning apparatus according to claim 5, wherein the one or the plurality of first constraint parameter values includes at least one of an upper limit value of a total use time of a charger, a charging mode of which is quick, a lower limit value of a total time of staying times of one or more vehicles staying at a point without being charged, a lower limit value of a difference between a demand target and predicted peak power, an upper limit value of a number of vehicles simultaneously staying at one point during business hours, and an upper limit value of a number of motor-driven vehicles, a ratio of a traveling distance of which to a cruising distance is equal to or larger than a threshold.

7. The schedule planning apparatus according to claim 1, wherein
the plurality of constraint parameter values includes one or a plurality of second constraint parameter values that affect correction cost of a transportation schedule, and
the one or the plurality of second constraint parameter values includes at least one of an upper limit value of a number of consecutive operations in which length of a cargo pickup or delivery time frame is equal to or smaller than a threshold, and a lower limit value of a difference between an end date and time of cargo pickup or delivery work and a cargo pickup or delivery time limit.

8. The schedule planning apparatus according to claim 1, wherein one or more parameter values included in the plurality of parameter values or obtained from at least a part of the plurality of parameter values and affecting the efficiency are at least one of a number of motor-driven vehicles running short of residual electric energy or running out of electricity, a cargo volume that cannot be transported, a number of vehicles to be used, a transportation expense, a transportation time, a power consumption amount by transportation, a carbon dioxide emission amount by the transportation, and an electric power fee required for charging.

9. The schedule planning apparatus according to claim 1, wherein the target schedule combination is a schedule combination in which the efficiency and the correction easiness are Pareto optimum or a schedule combination in which evaluation of the efficiency and the correction easiness is best.

10. The schedule planning apparatus according to claim 1, wherein the output unit performs at least one of (a) to (d) described below:
(a) displaying, on a display apparatus or a remote computer, a transportation schedule and/or a charging schedule in the target schedule combination;
(b) transmitting, for at least one transportation vehicle among the plurality of transportation vehicles, to an information processing terminal present in the transportation vehicle, information representing a transportation schedule portion and/or a charging schedule portion corresponding to the transportation vehicle in the target schedule combination;
(c) transmitting, for at least one point among the plurality of points, to an information processing terminal present at the point, information representing a transportation schedule portion and/or a charging schedule portion corresponding to the point in the target schedule combination; and
(d) transmitting, for at least one chargeable point among the plurality of points, to a charging control apparatus that controls a charger present at the point, charging control information conforming to a charging schedule portion corresponding to the point in the target schedule combination.

11. A schedule planning method for executing, with a computer:
receiving input of a plurality of parameter values used for planning of a schedule combination including a transportation schedule for transporting a plurality of pieces of cargo to a plurality of points with a plurality of transportation vehicles including a plurality of motor-driven vehicles that require charging and a charging schedule that is a schedule for charging the plurality of motor-driven vehicles and is based on the transportation schedule;
planning one or a plurality of schedule combinations based on the plurality of parameter values;
evaluating, for each of the one or the plurality of schedule combinations, efficiency that is efficiency of transportation and correction easiness that is easiness of schedule correction; and
outputting information based on at least a part of a target schedule combination among the one or the plurality of schedule combinations, wherein
the plurality of parameter values includes a plurality of prediction parameter values and one or a plurality of kinds of constraint parameter value combinations,
the prediction parameter values are prediction values for parameter names,
one or a plurality of constraint parameter values are present for each of a plurality of constraint parameter names,
for each of the one or the plurality of kinds of constraint parameter value combinations, the constraint parameter value combination is a combination including a plurality of constraint parameter values respectively corresponding to the plurality of constraint parameter names,
a constraint parameter value of at least one constraint parameter name affects the correction easiness, and
the target schedule combination is a schedule combination in which the efficiency and the correction easiness are relatively high.
